(19) United States
(12) Patent Application Publication
(10) Pub. No.: US 2009/0188423 A1
(43) Pub. Date: Jul. 30, 2009

(54) Securing device

(76) Inventor: Leonid Petrenko, Sun City, AZ (US)

Correspondence Address: James Ray & Associates, 2640 Pitcairn Road, Monroeville, PA, 15146, US

(21) Appl. No.: 12/148,024

(22) Filed: Apr. 16, 2008

Related U.S. Application Data
(60) Provisional application No. 61/023,682, filed on Jan. 25, 2008.

(51) Int. Cl. G09F 17/00

(52) U.S. Cl. 116/173

(57) ABSTRACT

A securing device for securing a flag having a grommet to a cord is provided. Such securing device includes a support member manufactured from a predetermined material and having a first predetermined shape and a first predetermined size. Such support member further having at least one aperture disposed therethrough at a predetermined location. Such aperture has a second predetermined size and is capable of being threaded with a cord for securing such cord to such support member, such cord has a third predetermined size. A securing mechanism is operably connectable to such support member for securing such flag to such support member.

### CROSS REFERENCE TO RELATED APPLICATION

This patent application is related to and claims priority from U.S. Provisional Patent Application Ser. No. 61/023,682 filed Jan. 25, 2008.

### FIELD OF THE INVENTION

The present invention relates, in general, to securing devices and, more particularly, this invention relates to a securing device for securing a flag having a grommet to a cord.

### BACKGROUND OF THE INVENTION

Prior to the conception and development of the present invention, flags, as are generally well known in the prior art, have been secured to the cord of a flagpole via snap-on hooks. However, on occasion, such snap-on hooks have become disengaged resulting in the flag becoming tangled, ripped, damaged, etc. Furthermore, attaching such flag to such cord using a snap-on hook results in the flag being some distance away from the flagpole which is undesirable.

Specifically of interest to the present invention are the following: Brewer, U.S. Pat. No. 6,857,386 provides a Flag fastening assembly for fastening the upper and lower portion of the leading edge of a flag to a flag supporting member in a manner that balances the weight of the flag about the axis of the flag supporting member and prevents furling. Each flag fastening assembly includes the combination of a swivel that is positioned longitudinally on the flag supporting member by set screws, each swivel including an outwardly extending member with spaced apart holes near an outer edge thereof and a cord member attached through such holes and linked through a grommet near an adjacent inner corner of the flag.

Slick, U.S. Pat. No. 3,063,406, provides a means for displaying a flag, such means including flag anchors having a helix portion terminating in a flag engaging portion, such anchors being meant to secure such flag in a taut manner.

Baxter, U.S. Pat. No. 6,059,241 discloses a clip-type fastening device having a deformable and resilient body which is constructed of first and second deformable aperture defining portions which in combination define an aperture within the body. First and second engaging members are integrally formed with the deformable aperture defining portions and are inter-engageable to clamp the body around a fixed member in a step-lock fashion. The aperture defining portions and engaging members may be deformed and separated in a twisting manner to release the body from the fixed member and a deformable clip portion is likewise separable to releasably secure an object such as a length of cord or a flag grommet.

Blume, U.S. Pat. No. 4,852,733 provides a clip for mounting a flag on a staff, pole or like support. Such clip is formed of wire bent to define a circular coil from which a first leg and a second leg tangentially extend for connecting a flag to a flagpole without use of cords.

### SUMMARY OF THE INVENTION

The present invention provides a securing device for securing a flag having a grommet to a cord. A support member is manufactured from a predetermined material and has a first predetermined shape and a first predetermined size. Such support member has at least one aperture disposed therethrough at a predetermined location. The at least one aperture has a second predetermined size and is capable of being threaded with a cord for securing such cord to the support member, such cord having a third predetermined size. A securing means is operably connectable to such support member for securing such flag to such support member.

### OBJECTS OF THE INVENTION

It is, therefore, one of the primary objects of the present invention to provide an easy to use means to secure a flag having a grommet to the cord of a flagpole.

Another object of the present invention is to provide a simple device to permit a user to attach a flag to the cord of a flagpole which will secure the flag closely adjacent to the cord.

Still another object of the present invention is to provide an inexpensive alternative to using snap-on hooks to secure a flag to a flagpole cord.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention in which the securing device includes a support member having a first and a second recessed portion for use in securing a cord to the support member and such support member further includes a raised portion for insertion through a grommet of a flag.

FIG. 2 is a partial perspective view of the invention according to one embodiment of the securing device in which the support member includes four apertures capable of being threaded with a cord.

FIG. 3 is a partial perspective view of the invention according to one embodiment of the securing device in which a portion of a cord is being inserted into an aperture disposed through the support member.

FIG. 4 is a partial perspective view of the invention according to one embodiment of the invention in which a portion of a cord has being inserted into an aperture disposed through such support member and such cord is being secured around recessed portions of such securing device.

FIG. 5A is a partial perspective view of the invention according to one embodiment of the invention in which a raised portion of such support member has been inserted through the grommet of a flag and a pin type securing member having a hinged member is being implemented; the pin type member has been inserted into the aperture on the substantially raised portion.

FIG. 5B is a partial perspective view of the invention according to one embodiment of the invention in which a raised portion of such support member has been inserted through the grommet of a flag and a pin type securing member having a hinged member is being implemented; the pin type member has been inserted into the aperture on the substantially raised portion and the hinged member is in the closed position thereby securing the flag to the support member.

FIG. 6 is a partial perspective view of the invention according to one embodiment of the invention in which a raised portion of such support member has been inserted through the grommet of a flag, such raised portion being threaded for receiving a nut, thereby enabling a user to secure such nut to the threaded raised portion and secure such flag in place.

FIG. 7 is a partial perspective view of the invention according to one embodiment of the invention in which an aperture disposed through the support member is threaded for receiving a threaded member.

FIG. 8 is a partial perspective view of the invention according to one embodiment of the securing device in which the support member includes four apertures for securing a cord and a fifth threaded aperture for alignment with the grommet of a flag and thereafter for receiving a threaded member for securing such flag to such support member and such cord.

FIG. 9 is a partial perspective view of the invention according to one embodiment of the invention in which the support member includes an aperture disposed therethrough for receiving a round head type fastener.

FIG. 10 is a partial perspective rear view of the invention according to one embodiment of the invention in which a round head type fastener has been inserted through a flag grommet aligned with an aperture disposed through such support member and in which the bendable prongs of the round head type fastener have been bent in opposite directions thereby securing such flag to the support member.

FIG. 11 is a partial perspective view of the invention according to one embodiment of the securing device in which a nut and bolt combination may be used to secure a flag to such support member.

FIG. 12 is a partial perspective view of the invention according to one embodiment of the invention in which a spring-loaded hinged member is operably connected to the substantially raised portion.

FIG. 13 is a partial perspective view of the invention according to one embodiment of the invention in which a spring-loaded hinged member is operably connected to the substantially raised portion.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

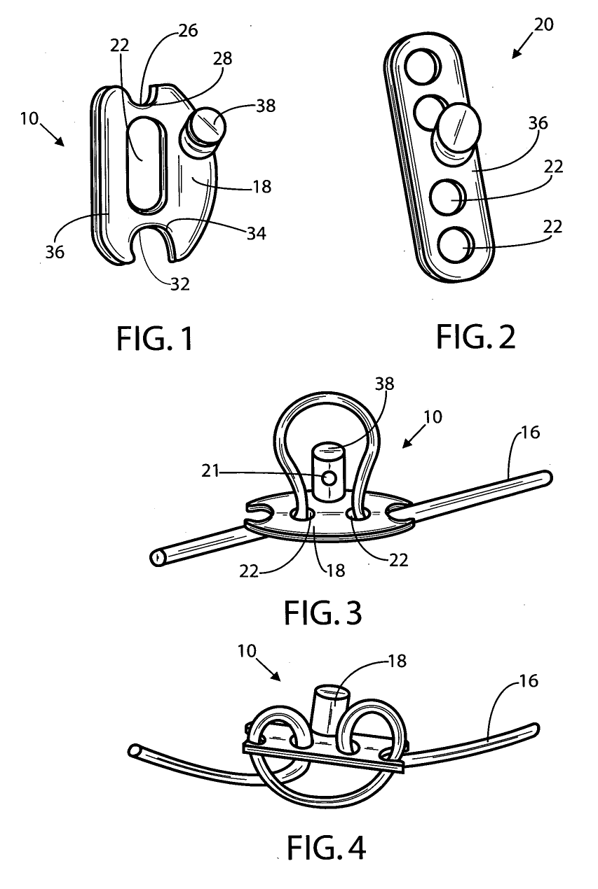

Reference is now made, more particularly, to FIGS. 1-13.

As illustrated in FIGS. 1,3,4, 5A and 5B, a securing device, generally designated 10, for securing a flag 12 having a grommet 14 to a cord 16 is provided. Such securing device 10 includes a support member 18 manufactured from a predetermined material and having a first predetermined shape and a first predetermined size.

It is presently preferred that such first predetermined material is at least one of a metal, a plastic, and a combination thereof. It is presently most preferred that such first predetermined material is a metal.

The support member 18 has at least one aperture 22 disposed therethrough at a predetermined location. Such aperture 22 has a second predetermined size and is capable of being threaded with such cord 16 for securing such cord 16 to the support member 18, such cord 16 having a third predetermined size.

A securing means 24 is operably connectable to the support member for securing such flag 12 to the support member 18.

It is presently preferred that such securing means 24 is at least one of a pin type fastener, screw type fastener, round head type fastener, twist tie type fastener, bendable prong type fastener, cuff link type fastener, bolt type fastener, threaded member type fastener, a snap type fastener, and a combination nut and bolt type fastener.

According to a first embodiment of the invention, the support member 18 has at least one aperture 22 disposed therethrough at a predetermined location and has a first recessed portion 26 at a first predetermined end 28 thereof and a second recessed portion 32 at a second predetermined end 34 thereof for use in attaching such cord 16 to the support member 18.

It is presently preferred that such support member 18 includes a substantially flat portion 36, through which the at least one aperture 22 is disposed, and a substantially raised portion 38 for receiving such grommet 14 of such flag 12, each of the portions having a predetermined shape and a predetermined size.

According to the presently preferred embodiment, the substantially raised portion 38 includes at least one aperture 21 extending therethrough at a predetermined location thereon for receiving such securing means 24 after the raised portion 38 has been inserted through such grommet 14. It is presently preferred that such securing means 24 is at least one of a pin type fastener, a screw type fastener, a round head type fastener, a twist tie type fastener, a bendable prong type fastener, a cuff link type fastener, bolt type fastener, threaded member type fastener, a snap type fastener, and a combination nut and bolt type fastener.

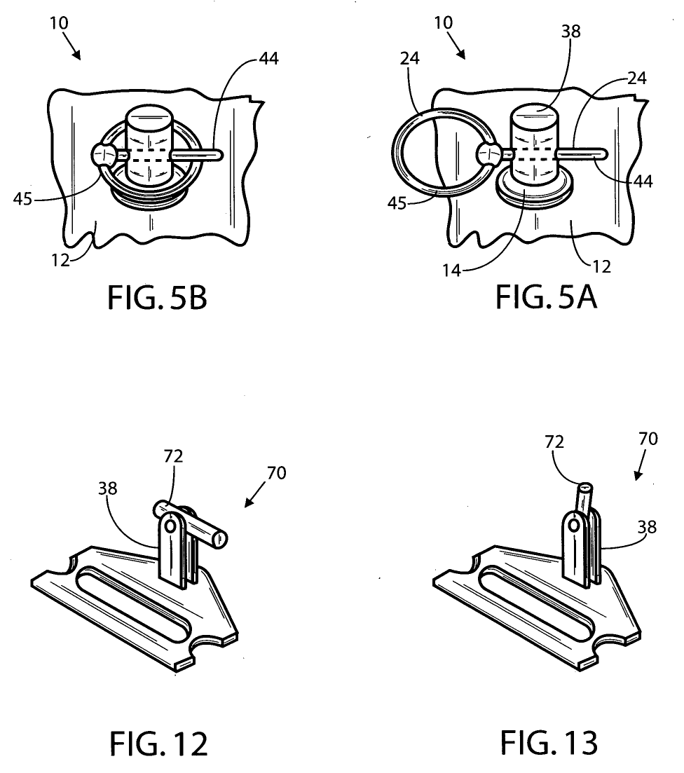

As illustrated in FIGS. 5A and 5B, It is presently most preferred that such securing means 24 is a pin member 44 having a first predetermined size, a first predetermined shape and a predetermined length, such pin member 44 being for inserting into such at least one aperture 21 on such raised portion 38 after a flag grommet 14 has been placed over such raised portion 38, such pin member 44 further including a hinged member 45 operably connected thereto at a predetermined end thereof, the hinged member 45 being moveable between an open position for allowing the pin member 44 to be inserted into such at least one aperture 21 and a closed position for securing such pin member 44 to such raised portion 38 such that the flag 12 is secured to the securing device 10.

Referring to FIG. 2, according to a second embodiment, the securing device, generally designated 20, has a substantially flat portion 36 which includes at least four apertures 22 capable of being threaded with such cord 16 for securing such cord 16 to the support member 18.

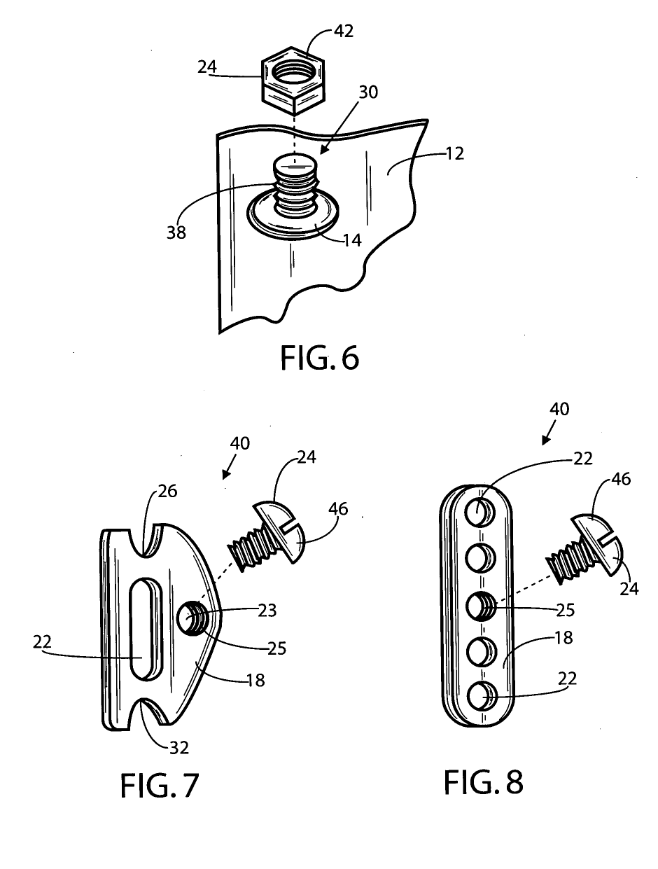

Referring to FIG. 6, according to a third embodiment of the invention, the securing device, generally designated 30, has a raised portion 38 threaded for receiving a nut 42. According to this particular embodiment, it is presently preferred that such securing means 24 is such nut 42, such nut being capable of being screwed onto the raised portion 38 after the raised portion 38 has been inserted into such grommet 14 thereby securing such flag 12 to the support member 18.

Referring to FIG. 7, according to a fourth embodiment of the invention, the securing device, generally designated 40, includes at least one aperture 22 disposed therethrough such support member 18 an equal distance between the first 26 and the second 32 recessed portions and at least a second aperture 23 disposed through such support member 18, the second aperture 23 being for alignment with such grommet 14 and for receiving such securing means 24.

Again referring to FIG. 7 and also to FIG. 8, according to still another embodiment, such support member 18 includes a plurality of apertures 22 disposed therethrough at predetermined locations and a predetermined aperture 25 is threaded for receiving and securing a threaded member 46 therein. In this particular embodiment the securing means 24 is a threaded member 46, such threaded member 46 being screwed into such threaded aperture 25 after such grommet 14 has been aligned with such threaded aperture 25.

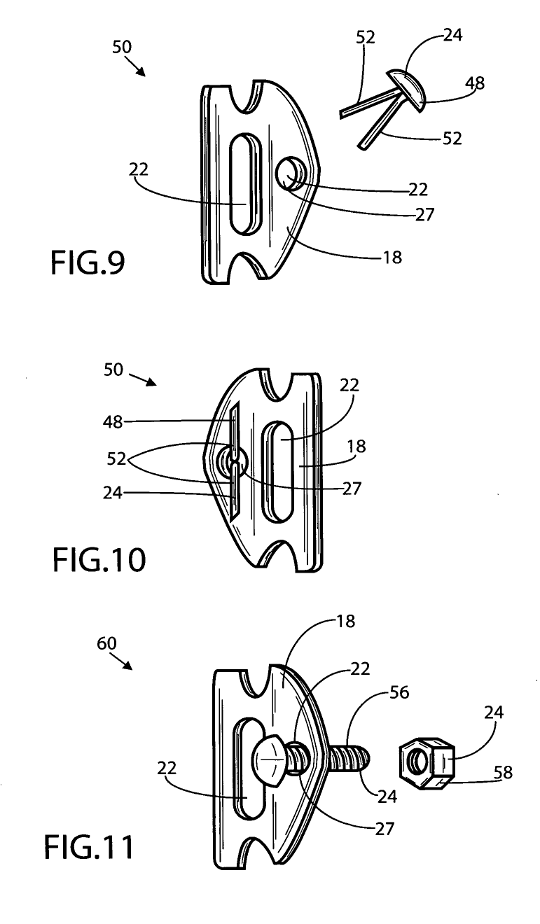

As illustrated in FIG. 9 and FIG. 10, in still another embodiment of the invention, the securing device, generally designated 50, includes such support member 18 having a plurality of apertures 22 and such securing means 24 being a round head type fastener 48 having at least two bendable shanks 52 attached thereto for insertion through such grommet 14 and through a predetermined aperture 27 and thereafter such shanks 52 being capable of being bent in opposite directions for securing such flag 12 to the support member 18.

In an additional embodiment of the invention, as illustrated in FIG. 11, the securing device, generally designated 60, includes such support member 18 having a plurality of apertures 22 disposed therethrough and the securing means 24 includes a nut and bolt combination, the bolt 56 being capable of being inserted through both of a predetermined aperture 27 and such grommet 14, such grommet 14 being aligned with the predetermined aperture 27, and thereafter the bolt 56 being capable of being screwed into the nut 58.

In yet another embodiment of the invention, as illustrated in FIG. 12 and FIG. 13, the securing device, generally designated 70 includes a substantially raised portion 38 having a spring-loaded hinged member 72 disposed adjacent an upper end thereof. Such spring-loaded hinged member 72 has a predetermined size and a predetermined shape. Such spring-loaded hinged member 72 is moveable between a first position, as depicted in FIG. 13, wherein the spring-loaded hinged member 72 is substantially parallel to the substantially raised portion 38 for allowing the substantially raised portion 38 to be inserted through such flag grommet 14 and a second position, as depicted in FIG. 12, wherein the spring-loaded hinged member 72 is substantially perpendicular to the substantially raised portion 38 for securing such flag 12 to the device 70. It is presently preferred that the spring-loaded hinged member 72 automatically at least one of returns to and occupies such second position when not being manipulated by a user.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

1. A securing device for securing a flag having a grommet to a cord comprising:
a. a support member manufactured from a predetermined material and having a first predetermined shape and a first predetermined size, said support member further having at least one aperture disposed therethrough at a predetermined location, said aperture having a second predetermined size and being capable of being threaded with a cord for securing such cord to said support member, such cord having a third predetermined size; and
b. a securing means operably connectable to said support member for securing such flag to said support member.

2. A securing device according to claim 1 wherein said support member has at least one aperture disposed therethrough at a predetermined location thereon and a first recessed portion at a first predetermined end thereof and a second recessed portion at a second predetermined end thereof for use in attaching such cord to said support member.

3. A securing device according to claim 2 wherein said device includes at least one aperture disposed therethrough said support member an equal distance between said first and said second recessed portions and at least a second aperture disposed through said support member, said second aperture being for alignment with such grommet and for receiving said securing means.

4. A securing device according to claim 3 wherein said securing means is cuff link type fastener.

5. A securing device according to claim 1 wherein said support member includes a substantially flat portion, through which said at least one aperture is disposed, and a substantially raised portion for receiving such grommet of such flag, each of said portions having a predetermined shape and a predetermined size.

6. A securing device according to claim 5 wherein said raised portion is threaded for receiving a nut.

7. A securing device according to claim 6 wherein said securing means is said nut, said nut being capable of being screwed onto said raised portion after said raised portion has been inserted into such grommet thereby securing said flag to said support member.

8. A securing device according to claim 5 wherein said substantially raised portion includes at least one aperture extending therethrough at a predetermined location thereon for receiving said securing means after said raised portion has been inserted through such grommet.

9. A securing device according to claim 8 wherein said securing means is at least one of a pin type fastener, a screw type fastener, a round head type fastener, a twist tie type fastener, a bendable prong type fastener, a cuff link type fastener, bolt type fastener, threaded member type fastener, snap type fastener, and a combination nut and bolt type fastener.

10. A securing device according to claim 1 wherein said securing means is a cuff link type fastener.

11. A securing device according to claim 5 wherein said substantially flat portion includes at least four apertures capable of being threaded with such cord for securing such cord to said support member.

12. A securing device according to claim 1 wherein said first predetermined material is at least one of a metal, a plastic, and a combination thereof.

13. A securing device according to claim 1 wherein said first predetermined material is a metal.

14. A securing device according to claim 1 wherein said support member includes a plurality of apertures disposed therethrough at predetermined locations and a predetermined aperture is threaded for receiving and securing a threaded member therein.

15. A securing device according to claim 14 wherein said securing means is a threaded member, said threaded member being screwed into said threaded aperture after such grommet has been aligned with such threaded aperture.

16. A securing device according to claim 1 wherein said support member includes a plurality of apertures and said securing means is a round head type fastener having at least two bendable shanks attached thereto for insertion through such grommet and through a predetermined aperture and thereafter said shanks being capable of being bent in opposite directions for securing such flag to said support member.

17. A securing device according to claim 1 wherein said support member includes a plurality of apertures disposed therethrough and said securing means includes a nut and bolt combination, said bolt being capable of being inserted through both of a predetermined aperture and such grommet, such grommet being aligned with said predetermined aperture, and thereafter said bolt being capable of being screwed into said nut.

18. A securing device according to claim 8 wherein said securing means is a pin member having a first predetermined size, a first predetermined shape and a predetermined length, said pin member being for inserting into said at least one aperture on said raised portion after a flag grommet has been placed over said raised portion, said pin member further including a hinged member operably connected thereto at a predetermined end thereof, said hinged member being moveable between an open position for allowing said pin member to be inserted into said at least one aperture and a closed position for securing said pin member to said raised portion such that said flag is secured to said securing device.

19. A securing device according to claim 5 wherein said substantially raised portion includes a spring-loaded hinged member disposed adjacent an upper end thereof, said spring-loaded hinged member having a predetermined size and a predetermined shape, said spring-loaded hinged member being moveable between a first position wherein said spring-loaded hinged member is substantially parallel to said substantially raised portion for allowing said substantially raised portion to be inserted through such flag grommet and a second position wherein said spring-loaded hinged member is substantially perpendicular to said substantially raised portion for securing such flag to said device, said spring-loaded hinged member automatically at least one of returning to and occupying said second position when not being manipulated by a user.
